(19) United States
(12) Patent Application Publication
(10) Pub. No.: US 2025/0175255 A1
(43) Pub. Date: May 29, 2025

(54) TRANSMITTING AND RECEIVING DEVICE FOR QUANTUM KEY DISTRIBUTION BASED ON CHIP

(71) Applicant: KOREA INSTITUTE OF SCIENCE AND TECHNOLOGY, Seoul (KR)

(72) Inventors: Sang Wook HAN, Seoul (KR); Min Ki WOO, Seoul (KR); Chang Hoon PARK, Seoul (KR); Hyungjun HEO, Seoul (KR); Hyounghan KWON, Seoul (KR); Hojoong JUNG, Seoul (KR)

(73) Assignee: KOREA INSTITUTE OF SCIENCE AND TECHNOLOGY, Seoul (KR)

(21) Appl. No.: 18/943,602

(22) Filed: Nov. 11, 2024

(30) Foreign Application Priority Data
Nov. 24, 2023 (KR) 10-2023-0165152

(51) Int. Cl. H04B 10/532; H04B 10/516; H04B 10/556; H04B 10/67; H04B 10/85; H04L 9/08

(52) U.S. Cl. CPC H04B 10/532; H04B 10/5161; H04B 10/5561; H04B 10/676; H04B 10/85; H04L 9/0819; H04L 9/0858

(57) ABSTRACT

A transmitting and receiving device for quantum key distribution based on a chip comprising a base including one light entrance and exit; a first beam splitter, reflecting part of an optical signal incident through a first optical path on a second optical path and transmit a remaining part of the optical signal to a third optical path; a first modulator modulating a phase of an optical signal reflected from the first beam splitter and incident on the second optical path; a second modulator delaying the optical signal transmitted from the first beam splitter and incident on the third optical path for a predetermined period of time and modulate a phase of the optical signal; and a polarization splitter-rotator transmitting an optical signal incident from the second modulator, with a time difference relative to an optical signal incident from the first modulator, to the one light exit.

### DESCRIPTION OF GOVERNMENT-SPONSORED RESEARCH

This research was supported by the Ministry of Science and ICT [Project Identification Number: 1711193304, Subproject Number: 2020-0-00890-004, Project Name: Advancement of Quantum Cryptography Communication Integration and Transmission Technology, Project Title: Development of Trusted Node Core and Interface for Ensuring Interoperability between QKD Protocols].

This research was supported by the Ministry of Science and ICT [Project Identification Number: 9991008602, Subproject Number: COMPA2022SCPO_B_0210, Project Name: Pilot Project for Promoting the Commercialization of Public Research Results in Scientific Security (National Police Agency, Ministry of Science and ICT), Project Title: Development of Quantum Technology-Based IP Cameras to Prevent Security Issues].

This research was supported by the Ministry of Science and ICT [Project Identification Number: 1055001202, Subproject Number: 2021M1A2A2043892, Project Name: Climate Change Response Technology Development, Project Title: Development of Quantum Random Number Generator-Based Encryption and Decryption Devices and Quantum Cryptography Technology for Secure Communication in Distributed Resource Integrity Management Platforms].

### CROSS REFERENCE TO RELATED APPLICATION

The present application claims priority to Korean Patent Application No. 10-2023-0165152, filed on Nov. 24, 2023, the entire contents of which is incorporated herein for all purposes by this reference.

### BACKGROUND OF THE INVENTION

### Field of the Invention

The present invention relates to a transmitting and receiving device for quantum key distribution based on a chip, and more specifically, to a transmitting and receiving device for quantum key distribution based on a chip, configured to allow only a single polarization to pass through.

### Description of the Related Art

A quantum key distribution (QKD) system is a system in which two communication devices, i.e., a transmitting device (Alice) and a receiving device (Bob), use photons as a communication medium to distribute a quantum key.

The QKD is a cryptographic technology that uses the principles of quantum mechanics to securely share a secret key for an encrypted message.

Using the QKD method, a randomly shared secret key may be generated between a transmitter and a receiver that are intended to communicate a message, and this key may be used to encrypt and decrypt the message.

The important and unique characteristic of QKD is that the two parties communicating may always detect the presence of a third party (Eve) attempting to eavesdrop.

This is based on the principles of quantum mechanics and generally, on the principle of quantum measurement, which states that the process of measuring a quantum system in a superposition state generally collapses the superposition state.

Unlike conventional communication, which uses wavelength or amplitude for communication, quantum cryptography transmits signals at the level of individual photons. Quantum signals may be encoded and transmitted using various resources at the photon level, such as polarization, phase, time bin, and path.

Meanwhile, recent research has been actively conducted on implementing the quantum optical system of QKD system in the form of a chip using nanophotonics technology.

The QKD chip using a polarization encoding method according to the conventional technology, as shown in Korean Patent Publication No. 10-1979328, consists of four light sources and four detectors, which presents limitations in terms of size and cost.

In addition, when the quantum optical system is implemented in the form of a chip, the individual components within the chip become polarization-dependent.

Therefore, when attempting to use polarization, there is a problem in obtaining the desired results due to polarization dependence.

### DOCUMENTS OF RELATED ART

(Patent Document 1) Korean Patent Publication No. 10-1979328 (published on May 16, 2019)

### SUMMARY OF THE INVENTION

The present invention is directed to solving the aforementioned problems in the related art, with the object of providing a transmitting and receiving device for quantum key distribution based on a chip, which minimizes size by using a single light source and is configured to allow only a single polarization to pass through.

To achieve the aforementioned object, there is provided a transmitting device for quantum key distribution based on chip, according to the present invention. The transmitting device may include: a base formed with one light entrance and one light exit; a first beam splitter positioned inside the base and disposed in a first optical path extending from the light entrance, reflecting part of an optical signal incident through the first optical path on a second optical path and allowing a remaining portion to be transmitted into a third optical path; a first modulator positioned inside the base to modulate a phase of an optical signal reflected from the first beam splitter and incident on the second optical path; and a second modulator positioned inside the base to delay an optical signal transmitted from the first beam splitter and incident on the third optical path for a predetermined period of time and to modulate a phase of the optical signal; and a polarization splitter-rotator positioned inside the base, and transmitting, with a time difference, an optical signal incident from the second modulator and an optical signal incident from the first modulator to the one light exit.

In addition, in the transmitting device for quantum key distribution based on chip, according to the present invention, the first modulator may include: a second beam splitter configured to reflect part of an optical signal reflected from the first beam splitter and incident through the second optical path on a second-first optical path, and to transmit a remaining portion of the optical signal into a second-second optical path; a first phase modulator configured to modulate a phase of an optical signal incident from the second beam splitter through the second-first optical path; a second phase modulator configured to modulate a phase of an optical signal incident from the second beam splitter through the second-second optical path; and a third beam splitter configured to receive an optical signal incident from the first phase modulator and an optical signal incident from the second phase modulator.

In addition, in the transmitting device for quantum key distribution based on chip, according to the present invention, the second modulator may include: an optical signal delay part configured to delay an optical signal transmitted from the first beam splitter and incident through the third optical path for a predetermined period of time and then emits the optical signal; a fourth beam splitter configured to transmit part of an optical signal incident through the optical signal delay part on a third-first optical path and reflect a remaining part of the optical signal to a third-second optical path; a third phase modulator configured to modulate a phase of an optical signal incident from the fourth beam splitter through the third-first optical path; a fourth phase modulator configured to modulate a phase of an optical signal incident from the fourth beam splitter through the third-second optical path; and a fifth beam splitter configured to receive an optical signal incident from the third phase modulator and an optical signal incident from the fourth phase modulator.

In addition, in the transmitting device for quantum key distribution based on chip, according to the present invention, phase modulation values of the first phase modulator and the second phase modulator provided in the first modulator, and the third phase modulator and the fourth phase modulator provided in the second modulator, may be controlled such that the intensity or phase of the optical signal incident on the polarization splitter-rotator from the second modulator, with a time difference relative to the optical signal incident on the polarization splitter-rotator from the first modulator, is modulated.

In addition, in the transmitting device for quantum key distribution based on chip, according to the present invention, the phase modulation values of the first phase modulator and the second phase modulator in the first modulator may be controlled to be identical, and the phase modulation values of the third phase modulator and the fourth phase modulator in the second modulator may be controlled to be identical, such that the optical signal incident on the polarization splitter-rotator from the second modulator, with a time difference relative to the optical signal incident on the polarization splitter-rotator from the first modulator, has a phase difference.

In addition, in the transmitting device for quantum key distribution based on chip, according to the present invention, the phase modulation values of the first phase modulator and the second phase modulator in the first modulator may be controlled so that a phase difference between an optical signal emitted from the first phase modulator and an optical signal emitted from the second phase modulator is x, and the phase modulation values of the third phase modulator and the fourth phase modulator in the second modulator may be controlled so that a phase difference between an optical signal emitted from the third phase modulator and an optical signal emitted from the fourth phase modulator is zero, resulting in an optical signal being emitted only from the second modulator.

In addition, in the transmitting device for quantum key distribution based on chip, according to the present invention, the phase modulation values of the first phase modulator and the second phase modulator in the first modulator may be controlled so that a phase difference between an optical signal emitted from the first phase modulator and an optical signal emitted from the second phase modulator is zero, and the phase modulation values of the third phase modulator and the fourth phase modulator in the second modulator may be controlled so that a phase difference between an optical signal emitted from the third phase modulator and an optical signal emitted from the fourth phase modulator is x, resulting in an optical signal being emitted only from the first modulator.

In addition, in the transmitting device for quantum key distribution based on chip, according to the present invention, the polarization splitter-rotator may polarization-modulate and combine an optical signal incident from the first modulator, and intactly combine an optical signal incident from the second modulator.

In addition, in the transmitting device for quantum key distribution based on chip, according to the present invention, an additional light entrance may be formed in the base.

To achieve the aforementioned object, there is provided a receiving device for quantum key distribution based on chip, according to the present invention. The receiving device may include: a base with one light entrance and two light exits formed; a polarization splitter-rotator positioned inside the base and disposed on a first optical path extending from the light entrance; a first modulator positioned inside the base and configured to modulate a phase of an optical signal incident from the polarization splitter-rotator through a second optical path; a second modulator positioned inside the base and configured to modulate a phase of an optical signal incident from the polarization splitter-rotator through a third optical path and delay an emitted optical signal for a predetermined period of time; and a first beam splitter positioned inside the base and configured to, depending on an interference result, transmit an optical signal incident from the first modulator and an optical signal incident from the second modulator to one of the two light exits.

In addition, in the receiving device for quantum key distribution based on chip, according to the present invention, the first modulator may include: a second beam splitter configured to reflect part of an optical signal reflected from the polarization splitter-rotator and incident through the second optical path on a second-first optical path and transmit a remaining part of the optical signal to a second-second optical path; a first phase modulator configured to modulate a phase of an optical signal incident from the second beam splitter through the second-first optical path; a second phase modulator configured to modulate a phase of an optical signal incident from the second beam splitter through the second-second optical path; and a third beam splitter configured to receive an optical signal incident from the first phase modulator and an optical signal incident from the second phase modulator.

In addition, in the receiving device for quantum key distribution based on chip, according to the present invention, the second modulator may include: a fourth beam splitter configured to transmit part of an optical signal incident from the polarization splitter-rotator through the second optical path to a third-first optical path and reflect a remaining part of the optical signal to a third-second optical path; a third phase modulator configured to modulate a phase of an optical signal incident from the fourth beam splitter through the third-first optical path; a fourth phase modulator configured to modulate a phase of an optical signal incident from the fourth beam splitter through the third-second optical path; a fifth beam splitter configured to receive an optical signal incident from the third phase modulator and an optical signal incident from the fourth phase modulator; and an optical signal delay part configured to delay an optical signal emitted from the fifth beam splitter for a predetermined period of time.

In addition, in the receiving device for quantum key distribution based on chip, according to the present invention, phase modulation values of the first phase modulator and the second phase modulator provided in the first modulator, and the third phase modulator and the fourth phase modulator provided in the second modulator, may be controlled such that the intensity or phase of the optical signal incident on the first beam splitter from the second modulator, with a time difference relative to the optical signal incident on the first beam splitter from the first modulator, is modulated.

In addition, in the receiving device for quantum key distribution based on chip, according to the present invention, the polarization splitter-rotator, depending on a polarization mode of an optical signal incident through the first optical path, may either branch the optical signal incident through the first optical path as is or modulate polarization of a signal transmitted in a specific path and transmit the modulated signal.

Other specific details of the embodiments are included in the “detailed description of the invention” and the “drawings” attached hereto.

Advantages and features of the present invention and methods of achieving the advantages and features will be clear with reference to various embodiments described in detail below together with the accompanying drawings.

However, it should be understood that the present invention are not limited to the configuration of each of the embodiments disclosed below, but may also be implemented in a variety of other forms, and that each of the embodiments disclosed herein is provided only to make the disclosure of the present invention complete and to fully inform those skilled in the art to which the present invention belong of the scope of the present invention, and that the present invention are only defined by the scope of each claim of the appended claims.

According to the present invention, by being configured to use a single light source, the size of the device for quantum key distribution can be miniaturized.

In addition, by being configured to allow only a single polarization to pass through, the performance can be improved.

Further, by enabling the internal configuration of the transmitting device and receiving device to be implemented identically, the efficiency of device fabrication can be enhanced.

### BRIEF DESCRIPTION OF THE DRAWINGS

FIG. 1 is a view schematically illustrating a configuration of a transmitting device for quantum key distribution based on a chip, according to an embodiment of the present invention.

FIG. 2 is a view schematically illustrating a configuration of a receiving device for quantum key distribution based on a chip, according to an embodiment of the present invention.

### DETAILED DESCRIPTION OF THE INVENTION

It should be understood that before describing the present invention in detail, the terms and words used in the present specification are not to be interpreted unconditionally and without limitation in the general or dictionary meaning, and that the inventor of the present invention may appropriately define and use the concepts of various terms to best describe his/her own invention, and further that these terms and words are to be interpreted in a meaning and concept consistent with the technical spirit of the present invention.

That is, it should be understood that the terms used in the present specification are used only to describe preferred embodiments of the present invention and are not intended to specifically limit the content of the present invention, and that these terms are terms defined in consideration of the various possibilities of the present invention.

In addition, in the present specification, it should be understood that singular expressions may include plural expressions unless the context clearly indicates a different meaning, and similarly, the plural expressions may have a singular meaning.

Throughout the present specification, where a constituent element is described as “comprising/including” another element, which, unless specifically stated to the contrary, may mean to include any other constituent element and not to exclude any other constituent element.

Further, when a constituent element is described as “existing within, or being installed in connection with,” another constituent element, it should be understood that the constituent element may be directly connected to, installed in contact with, or installed spaced a certain distance apart from another constituent element, and that in case of being installed spaced a certain distance apart, there may be a third constituent element or means for fixing or connecting the constituent element to another constituent element, and the description of the third constituent element or means may be omitted.

In contrast, when a constituent element is described as being “directly connected” or “directly accessed” to another constituent element, it should be understood that there is no third constituent element or means.

Similarly, other expressions that describe the relationship between respective constituent elements, such as “between” and “directly between”, or “adjacent to” and “directly adjacent to”, should be interpreted in the same manner.

In addition, it should be understood that when the terms “one surface,” “the other surface,” “one side,” “the other side,” “first,” “second,” and the like, are used in the present specification, they are used to refer to one constituent element so that this one constituent element can be clearly distinguished from other constituent elements, and that the meaning of the corresponding constituent element is not limited by such terms.

In addition, when the terms relating to a position, such as “top,” “bottom,” “left,” “right,” and the like, are used in the present specification, it should be understood that they refer to a relative position in the corresponding drawing with respect to the corresponding constituent element, and should not be understood that the terms relating to a position refer to an absolute position, unless the absolute position is specified with respect to the constituent element.

Further, it should be understood that in the specification of the present invention, the terms “unit,” “device,” “module,” “apparatus,” and the like, when used, mean a unit capable of performing one or more functions or operations, which may be implemented in hardware or software, or a combination of hardware and software.

In addition, in specifying the reference numeral for each constituent element in each drawing, the present specification is intended to indicate that the same constituent element has the same reference numeral even though it is illustrated in different drawings, i.e., the same reference numeral throughout the specification refers to the same constituent element.

In the drawings accompanying the present specification, the size, position, coupling relationships, etc. of each of the constituent elements constituting the present invention may be exaggerated, reduced, or omitted in some respects in order to convey the spirit of the present invention with sufficient clarity or for convenience of description, and thus the proportions or scales may not be strictly accurate.

In addition, in describing the present invention below, detailed descriptions of the configuration, for example, of known art, including prior art, may be omitted where it is determined that such descriptions would unnecessarily obscure the subject matter of the present invention.

Hereinafter, a transmitting and receiving device for quantum key distribution based on a chip according to a preferred embodiment of the present invention will be described in detail with reference to the accompanying drawings.

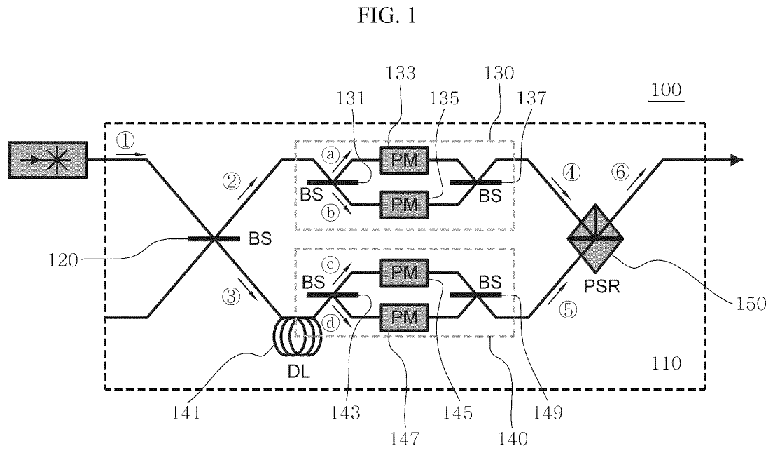

FIG. 1 is a view schematically illustrating a configuration of a transmitting device for quantum key distribution based on a chip, according to an embodiment of the present invention.

As illustrated in FIG. 1, a transmitting device 100 for quantum key distribution based on a chip, according to an embodiment of the present invention, may include a base 110, a first beam splitter 120, a first modulator 130, a second modulator 140, a polarization splitter-rotator (PSR) 150, and the like.

The transmitting device 100 for quantum key distribution according to the present invention may be implemented as a chip for optical devices integrated through a semiconductor process.

The base 110 described above may accommodate the first beam splitter 120, the first modulator 130, the second modulator 140, the PSR 150, and the like, which constitute the transmitting device 100 for quantum key distribution according to an embodiment of the present invention.

In a preferred embodiment of the present invention, the base 110 may be implemented as lithium niobate (LiNbO₃).

When the base 110 is implemented in lithium niobate (LiNbO₃), both passive elements such as a beam splitter, PSR, and active elements such as a phase modulator accommodated in the base 110 may exhibit good efficiency.

In addition to lithium niobate (LiNbO₃), the materials constituting the base 110 may be implemented in silicon (Si), indium phosphide (InP), and the like, but are not limited thereto.

In the transmitting device 100 for quantum key distribution according to an embodiment of the present invention, the base 110 may have one light entrance and one light exit formed therein.

The light entrance refers to a point at which a photon may enter an interior of the base 110, and the light exit refers to a point at which a photon may exit the base 110 to the outside.

In an embodiment of the present invention, two light entrances may be formed in the base 110 of the transmitting device 100 for quantum key distribution, the reason for forming two light entrances is to implement the same structure as a receiving device 200 for quantum key distribution, which is described below.

By implementing the same structure of the transmitting device 100 and the receiving device 200, the efficiency of device fabrication may be enhanced.

When two light entrances are formed in the base 110, only one light entrance is used to transmit an optical signal.

An optical signal output from a light source is incident on the base 110 through the light entrance, and an optical signal incident on the light entrance moves through a first optical path \textcircled{1} extending from the light entrance.

In embodiments of the present invention, the light source may be provided outside the device, or may be provided inside the device.

In embodiments of the present invention, it is assumed that a polarization mode of the optical signal output from the light source and incident on the light entrance is a transverse electric (TE) mode, which is a horizontal mode. However, this is only one embodiment and the present invention is not limited thereto.

In addition, the first beam splitter 120, first modulator 130, second modulator 140, PSR 150, and the like accommodated within the base 110 may be connected through optical paths to allow photons to move therebetween.

In addition, the first beam splitter 120, the first modulator 130, the second modulator 140, the PSR 150, and the like accommodated within the base 110 may be implemented, for example, to allow optical signals incident in TE mode to pass through, but the present invention is not limited thereto.

The first beam splitter 120 is positioned inside the base 110 and may be disposed in the first optical path \textcircled{1} extending from the light entrance.

The first beam splitter 120 may reflect part of an optical signal incident from the light entrance through the first optical path \textcircled{1} on a second optical path \textcircled{2} and transmit a remaining part thereof to a third optical path \textcircled{3}.

The first modulator 130 is positioned inside the base 110 and may modulate a phase of an optical signal reflected from the first beam splitter 120 and incident through the second optical path \textcircled{2}.

The first modulator 130 may include a second beam splitter 131, a first phase modulator 133, a second phase modulator 135, and a third beam splitter 137.

Here, the second beam splitter 131 may reflect part of an optical signal reflected from the first beam splitter 120 and incident through the second optical path \textcircled{2} on a second-first optical path \textcircled{a}, and transmit a remaining part thereof to a second-second optical path \textcircled{b}.

The first phase modulator 133 may modulate a phase of an optical signal incident from the second beam splitter 131 through the second-first optical path \textcircled{a}.

The second phase modulator 135 may modulate a phase of an optical signal incident from the second beam splitter 131 through the second-second optical path \textcircled{b}.

The third beam splitter 137 may receive an optical signal incident from the first phase modulator 133 and an optical signal incident from the second phase modulator 135.

The optical signal incident from the first phase modulator 133 and the optical signal incident from the second phase modulator 135 are combined in the third beam splitter 137, causing either constructive interference or destructive interference depending on a relative phase difference between the two optical signals.

The constructively interfered optical signal in the third beam splitter 137 is incident on the PSR 150 through a fourth optical path \textcircled{4}, and when destructive interference occurs at the third beam splitter 137, no optical signal is emitted to the fourth optical path \textcircled{4}.

Here, the constructive interference occurs at the third beam splitter 137 when the first phase modulator 133 and the second phase modulator 135 are controlled with an identical phase modulation value, and the destructive interference occurs at the third beam splitter 137 when the phase modulation value of the first phase modulator 133 and the second phase modulator 135 is controlled such that a phase difference between an optical signal emitted from the first phase modulator 133 and an optical signal emitted from the second phase modulator 135 is π.

The second modulator 140 is positioned inside the base 110 and may delay and phase modulate an optical signal transmitted from the first beam splitter 120 and incident on the third optical path \textcircled{3} for a predetermined period of time.

The second modulator 140 may include an optical signal delay part 141, a fourth beam splitter 143, a third phase modulator 145, a fourth phase modulator 147, and a fifth beam splitter 149.

The first modulator 130 and the second modulator 140 may be configured from optical elements including at least one of a lens, a polarizing filter, or a polarizing beam splitter.

Here, the optical signal delay part 141 may delay an optical signal transmitted from the first beam splitter 120 and incident through the third optical path for a predetermined period of time and then emit the optical signal.

The fourth beam splitter 143 may transmit part of an optical signal incident through the optical signal delay part 141 on a third-first optical path \textcircled{c} and reflect a remaining part thereof to a third-second optical path \textcircled{d}.

The third phase modulator 145 may modulate a phase of an optical signal incident from the fourth beam splitter 143 through the third-first optical path \textcircled{c}.

The fourth phase modulator 147 may modulate a phase of an optical signal incident from the fourth beam splitter 143 through the third-second optical path \textcircled{d}.

The fifth beam splitter 149 may receive an optical signal incident from the third phase modulator 145 and an optical signal incident from the fourth phase modulator 147.

The optical signal incident from the third phase modulator 145 and the optical signal incident from the fourth phase modulator 147 are combined in the fifth beam splitter 149, causing either constructive interference or destructive interference depending on a relative phase difference between the two optical signals.

The constructively interfered optical signal in the fifth beam splitter 149 is incident on the PSR 150 through the fifth optical path \textcircled{5}, and when the destructive interference occurs at the fifth beam splitter 149, no optical signal is emitted to the fifth optical path \textcircled{5}.

Here, the constructive interference occurs at the fifth beam splitter 149 when the third phase modulator 145 and the fourth phase modulator 147 are controlled with an identical phase modulation value, and the destructive interference occurs at the fifth beam splitter 149 when the phase modulation value of the third phase modulator 145 and the fourth phase modulator 147 is controlled such that a phase difference between an optical signal emitted from the third phase modulator 145 and an optical signal emitted from the fourth phase modulator 147 is π.

Meanwhile, the PSR 150 is positioned inside the base 110 and may receive an optical signal incident from the first modulator 130 through the fourth optical path \textcircled{4} and an optical signal incident from the second modulator 140 through the fifth optical path \textcircled{5}.

Here, an optical signal incident from the first modulator 130 on the PSR 150 through the fourth optical path \textcircled{4} and an optical signal incident from the second modulator 140 on the PSR 150 through the fifth optical path \textcircled{5} may be incident with a time difference.

The PSR 150 may transmit an optical signal incident from the first modulator 130 through the fourth optical path \textcircled{4} and an optical signal incident from the second modulator 140 through the fifth optical path \textcircled{5} to the light exit through the sixth optical path \textcircled{6}.

Here, the PSR 150 may polarization-modulate and combine an optical signal in TE mode incident from the first modulator 130 through the fourth optical path \textcircled{4} into TM mode and transmit the optical signal to the light exit through the sixth optical path \textcircled{6}, and may intactly combine an optical signal incident from the second modulator 140 through the fifth optical path \textcircled{5} as TE mode and transmit the optical signal to the light exit through the sixth optical path \textcircled{6}.

As described above, in the transmitting device 100 for quantum key distribution according to an embodiment of the present invention, any optical path before the PSR 150 may be implemented such that the optical signal is transmitted in TE mode, for example, but the present invention is not limited thereto.

In the transmitting device 100 for quantum key distribution according to an embodiment of the present invention, the phase modulation values of the phase modulators 133, 135, 145, and 147 provided in the first modulator 130 and the second modulator 140 may be controlled to modulate the intensity or phase of the optical signal incident on the PSR 150 from the second modulator 140, with a time difference relative to the optical signal incident on the PSR 150 from the first modulator 130.

Specifically, during phase modulation, the phase modulation values of the first phase modulator 133 and the second phase modulator 135 in the first modulator 130 are controlled identically, and the phase modulation values of the third phase modulator 145 and the fourth phase modulator 147 in the second modulator 140 are controlled identically. This ensures that the optical signal incident on the PSR 150 from the second modulator 140, with a time difference relative to the optical signal incident on the PSR 150 from the first modulator 130, has a phase difference.

For example, when the phase modulation values of the first phase modulator 133 and the second phase modulator 135 in the first modulator 130 are controlled identically to π, and the phase modulation values of the third phase modulator 145 and the fourth phase modulator 147 in the second modulator 140 are controlled identically to zero, then the optical signal incident on the PSR 150 from the second modulator 140, with a time difference relative to the optical signal incident on the PSR 150 from the first modulator 130, has a phase difference of π.

In addition, during intensity modulation, the phase modulation values of the first phase modulator 133 and the second phase modulator 135 in the first modulator 130 are controlled so that the phase difference between the optical signal emitted from the first phase modulator 133 and the optical signal emitted from the second phase modulator 135 is π. The phase modulation values of the third phase modulator 145 and the fourth phase modulator 147 in the second modulator 140 are controlled so that the phase difference between the optical signal emitted from the third phase modulator 145 and the optical signal emitted from the fourth phase modulator 147 is zero. This may ensure that the optical signal is incident on the PSR 150 only from the second modulator 140.

In addition, during intensity modulation, the phase modulation values of the first phase modulator 133 and the second phase modulator 135 in the first modulator 130 are controlled so that the phase difference between the optical signal emitted from the first phase modulator 133 and the optical signal emitted from the second phase modulator 135 is zero. The phase modulation values of the third phase modulator 145 and the fourth phase modulator 147 in the second modulator 140 are controlled so that the phase difference between the optical signal emitted from the third phase modulator 145 and the optical signal emitted from the fourth phase modulator 147 is π. This may ensure that the optical signal is incident on the PSR 150 only from the first modulator 130.

For example, when the phase modulation values of the first phase modulator 133 and the second phase modulator 135 in the first modulator 130 are controlled to zero and π, respectively, and the phase modulation values of the third phase modulator 145 and the fourth phase modulator 147 in the second modulator 140 are controlled identically to zero, then the two optical signals combined at the third beam splitter 137 in the first modulator 130, that is, the optical signal incident from the first phase modulator 133 and the optical signal incident from the second phase modulator 135, have a phase difference of π, causing destructive interference. When destructive interference occurs at the third beam splitter 137, the optical signal will not be emitted to the fourth optical path \textcircled{4}.

Further, the two optical signals combined at the fifth beam splitter 149 in the second modulator 140, that is, the optical signal incident from the third phase modulator 145 and the optical signal incident from the fourth phase modulator 147, have a phase difference of 0, resulting in constructive interference. The optical signal that undergoes constructive interference at the fifth beam splitter 149 is incident on the PSR 150 through the fifth optical path \textcircled{5}.

Accordingly, when the phase modulation values of the first phase modulator 133 and the second phase modulator 135 in the first modulator 130 are controlled so that the phase difference between the optical signal emitted from the first phase modulator 133 and the optical signal emitted from the second phase modulator 135 is π, and the phase modulation values of the third phase modulator 145 and the fourth phase modulator 147 in the second modulator 140 are controlled so that the phase difference between the optical signal emitted from the third phase modulator 145 and the optical signal emitted from the fourth phase modulator 147 is zero, the optical signal may be incident on the PSR 150 only from the second modulator 140.

In addition, when the phase modulation values of the first phase modulator 133 and the second phase modulator 135 in the first modulator 130 are controlled identically to zero, and the phase modulation values of the third phase modulator 145 and the fourth phase modulator 147 in the second modulator 140 are controlled to 0 and π, respectively, the two optical signals combined at the third beam splitter 137 in the first modulator 130, that is, the optical signal incident from the first phase modulator 133 and the optical signal incident from the second phase modulator 135, have a phase difference of zero, resulting in constructive interference. The optical signal that undergoes constructive interference at the third beam splitter 137 is incident on the PSR 150 through the fourth optical path \textcircled{4}.

Further, the two optical signals combined at the fifth beam splitter 149 in the second modulator 140, that is, the optical signal incident from the third phase modulator 145 and the optical signal incident from the fourth phase modulator 147, have a phase difference of π, resulting in destructive interference. When destructive interference occurs at the fifth beam splitter 149, the optical signal is not emitted to the fifth optical path \textcircled{5}.

Accordingly, when the phase modulation values of the first phase modulator 133 and the second phase modulator 135 in the first modulator 130 are controlled so that the phase difference between the optical signal emitted from the first phase modulator 133 and the optical signal emitted from the second phase modulator 135 is zero, and the phase modulation values of the third phase modulator 145 and the fourth phase modulator 147 in the second modulator 140 are controlled so that the phase difference between the optical signal emitted from the third phase modulator 145 and the optical signal emitted from the fourth phase modulator 147 is π, the optical signal may be incident on the PSR 150 only from the first modulator 130.

Meanwhile, in a quantum key distribution system, a decoy signal may be generated to detect the presence of an attacker. The decoy signal may be generated by controlling the phase modulation values of the phase modulators 133, 135, 145, and 147 provided in the first modulator 130 and the second modulator 140 and modulating the intensity of the optical signal incident on the PSR 150 from the second modulator 140, with a time difference relative to the optical signal incident on the PSR 150 from the first modulator 130.

Specifically, the phase modulation values of the first phase modulator 133 and the second phase modulator 135 in the first modulator 130 are controlled such that the phase difference between the optical signal emitted from the first phase modulator 133 and the optical signal emitted from the second phase modulator 135 becomes π, and the phase modulation values of the third phase modulator 145 and the fourth phase modulator 147 in the second modulator 140 are controlled such that the phase difference between the optical signal emitted from the third phase modulator 145 and the optical signal emitted from the fourth phase modulator 147 becomes zero, it is ensured that only the optical signal from the second modulator 140 is incident on the PSR 150. Further, the phase modulation values of the first phase modulator 133 and the second phase modulator 135 in the first modulator 130 are controlled such that the phase difference between the optical signal emitted from the first phase modulator 133 and the optical signal emitted from the second phase modulator 135 becomes zero, and the phase modulation values of the third phase modulator 145 and the fourth phase modulator 147 in the second modulator 140 are controlled such that the phase difference between the optical signal emitted from the third phase modulator 145 and the optical signal emitted from the fourth phase modulator 147 becomes π, it is ensured that only the optical signal from the first modulator 130 is incident on the PSR 150, thereby enabling the generation of a decoy signal.

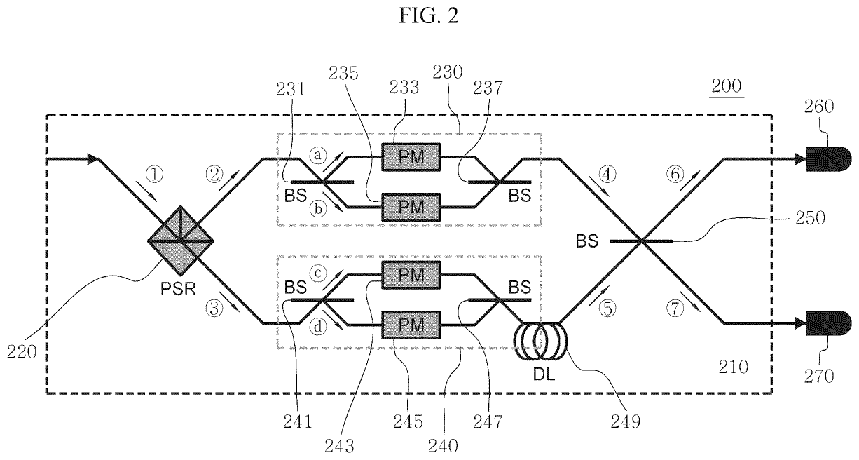

FIG. 2 is a view schematically illustrating the configuration of a receiving device for quantum key distribution based on a chip according to an embodiment of the present invention. The receiving device 200 for quantum key distribution based on a chip according to an embodiment of the present invention may be a device that receives and processes an optical signal transmitted by the transmitting device 100 in FIG. 1 through a quantum channel.

As illustrated in FIG. 2, the receiving device 200 for quantum key distribution based on a chip according to an embodiment of the present invention may include a base 210, a PSR 220, a first modulator 230, a second modulator 240, a first beam splitter 250, and the like.

The base 210 described above may accommodate the PSR 220, the first modulator 230, the second modulator 240, the first beam splitter 250, and the like, which constitute the receiving device 200 for quantum key distribution according to an embodiment of the present invention.

In the receiving device 200 for quantum key distribution according to an embodiment of the present invention, the base 210 may have one light entrance and two light exits formed therein.

The PSR 220, the first modulator 230, the second modulator 240, the first beam splitter 250, and the like accommodated within the base 210 may be connected through optical paths to allow photons to move therebetween.

In addition, the PSR 220, the first modulator 230, the second modulator 240, the first beam splitter 250, and the like, accommodated within the base 210, may be implemented, for example, to allow the efficient passage of an optical signal in TE mode, but the present invention is not limited thereto.

The PSR 220 is positioned inside the base 210 and may be disposed in the first optical path \textcircled{1} extending from the light entrance.

The optical signal transmitted from the transmitting device 100 in FIG. 1 through a quantum channel and received is incident through the light entrance and then incident on PSR 220 through the first optical path \textcircled{1}. The optical signal transmitted and received from the transmitting device 100 may be an optical signal in TE mode or an optical signal in TM mode. The PSR 220, when the optical signal incident through the first optical path \textcircled{1} is in TM mode, may polarization modulate the optical signal in TM mode to an optical signal in TE mode and allow the polarization-modulated optical signal in TE mode to be incident on the first modulator 230 through the second optical path \textcircled{2}. When the optical signal incident through the first optical path \textcircled{1} is in TE mode, the PSR 220 may branch the optical signal in TE mode as is and allow the optical signal in TM mode to be incident on the second modulator 240 through the third optical path \textcircled{3}.

Here, the optical signal incident through a quantum channel is polarization-controlled at the PSR 220 and incident on the first modulator 230 without time delay for the optical signal received with time delay from the transmitting device 100. For the optical signal received without time delay from the transmitting device 100, the optical signal is incident on the second modulator 240 with time delay, so that the two signals incident with a time difference need to be combined at the first beam splitter 250.

To this end, the light exit of the transmitting device 100 and the light entrance of the receiving device 200, which are connected through the quantum channel, may be disposed with a 90° offset.

As described above, when the light exit of the transmitting device 100 and the light entrance of the receiving device 200 are disposed with a 90° offset, the optical signal transmitted in TE mode from the transmitting device 100 may be received in TM mode by the receiving device 200, and the optical signal transmitted in TM mode from the transmitting device 100 may be received in TE mode by the receiving device 200.

Meanwhile, the first modulator 230 is positioned inside the base 210 and may modulate a phase of the optical signal incident on the PSR 220 through the second optical path \textcircled{2}.

The first modulator 230 may include a second beam splitter 231, a first phase modulator 233, a second phase modulator 235, and a third beam splitter 237.

Here, the second beam splitter 231 may reflect part of the optical signal incident on the PSR 220 through the second optical path \textcircled{2} to the second-first optical path \textcircled{a} and transmit a remaining part thereof to the second-second optical path \textcircled{b}.

The first phase modulator 233 may modulate a phase of an optical signal incident from the second beam splitter 231 through the second-first optical path \textcircled{a}.

The second phase modulator 235 may modulate a phase of an optical signal incident from the second beam splitter 231 through the second-second optical path \textcircled{b}.

The third beam splitter 237 may receive an optical signal incident from the first phase modulator 233 and an optical signal incident from the second phase modulator 235.

The optical signal incident from the first phase modulator 233 and the optical signal incident from the second phase modulator 235 are combined in the third beam splitter 237, causing either constructive interference or destructive interference depending on a relative phase difference between the two optical signals.

The constructively interfered optical signal in the third beam splitter 237 is incident on the first beam splitter 250 through the fourth optical path \textcircled{4}, and when destructive interference occurs at the third beam splitter 237, no optical signal is emitted to the fourth optical path \textcircled{4}.

Here, the constructive interference occurs at the third beam splitter 237 when the first phase modulator 233 and the second phase modulator 235 are controlled with an identical phase modulation value, and the destructive interference occurs at the third beam splitter 237 when the phase modulation value of the first phase modulator 233 and the second phase modulator 235 is controlled such that a phase difference between an optical signal emitted from the first phase modulator 233 and an optical signal emitted from the second phase modulator 235 is π.

Meanwhile, the second modulator 240 is positioned inside the base 210, and may modulate a phase of the optical signal incident on the PSR 220 through the third optical path \textcircled{3}, and delay the emitted optical signal for a predetermined period of time.

The second modulator 240 may include a fourth beam splitter 241, a third phase modulator 243, a fourth phase modulator 245, a fifth beam splitter 247, and an optical signal delay part 249.

Here, the fourth beam splitter 241 may transmit part of the optical signal incident on the PSR 220 through the third optical path \textcircled{3} to the third-first optical path \textcircled{c} and reflect a remaining part thereof to the third-second optical path \textcircled{d}.

The third phase modulator 243 may modulate a phase of an optical signal incident from the fourth beam splitter 241 through the third-first optical path \textcircled{c}.

The fourth phase modulator 245 may modulate a phase of an optical signal incident from the fourth beam splitter 241 through the third-second optical path \textcircled{d}.

The fifth beam splitter 247 may receive an optical signal incident from the third phase modulator 243 and an optical signal incident from the fourth phase modulator 245.

The optical signal incident from the third phase modulator 243 and the optical signal incident from the fourth phase modulator 245 are combined in the fifth beam splitter 247, causing either constructive interference or destructive interference depending on a relative phase difference between the two optical signals.

The constructively interfered optical signal in the fifth beam splitter 247 is incident on the first beam splitter 250 through the fifth optical path \textcircled{5}, and when the destructive interference occurs at the fifth beam splitter 247, no optical signal is emitted to the fifth optical path \textcircled{5}.

Here, the constructive interference occurs at the fifth beam splitter 247 when the third phase modulator 243 and the fourth phase modulator 245 are controlled with an identical phase modulation value, and the destructive interference occurs at the fifth beam splitter 247 when the phase modulation value of the third phase modulator 243 and the fourth phase modulator 245 is controlled such that a phase difference between an optical signal emitted from the third phase modulator 243 and an optical signal emitted from the fourth phase modulator 245 is π.

The optical signal delay part 249 may delay an optical signal incident from the fifth beam splitter 247 for a predetermined period of time and then emit the optical signal.

Meanwhile, the first beam splitter 250 is positioned inside the base 210 and may transmit an optical signal incident from the first modulator 230 through the fourth optical path \textcircled{4} and an optical signal incident from the second modulator 240 through the fifth optical path \textcircled{5} to one of two light exits, depending on the interference result.

Specifically, the first beam splitter 250 may reflect part of the optical signal incident on the first modulator 230 through the fourth optical path \textcircled{4} to the sixth optical path \textcircled{6} and transmit a remaining part thereof to the seventh optical path \textcircled{7}, and may reflect part of the optical signal incident on the second modulator 240 through the fifth optical path \textcircled{5} to the seventh optical path \textcircled{7} and transmit a remaining part thereof to the sixth optical path \textcircled{6}. In this case, the optical signal incident on the first modulator 230 through the fourth optical path \textcircled{4} and the optical signal incident on the second modulator 240 through the fifth optical path \textcircled{5} are combined at the first beam splitter 250, and constructive interference or destructive interference occurs depending on a relative phase difference of the two optical signals.

The sixth optical path \textcircled{6} described above is connected to the first light exit, the seventh optical path \textcircled{7} is connected to the second light exit, and each light exit is provided with a photodetector 260 or 270 that is capable of detecting an optical signal output from each light exit.

As described above, in the receiving device 200 for quantum key distribution according to an embodiment of the present invention, any optical path after the PSR 220 may be implemented such that the optical signal is transmitted in TE mode, for example, but the present invention is not limited thereto.

The receiving device 200 for quantum key distribution according to an embodiment of the present invention, similar to the transmitting device 100, may modulate the intensity or phase of the optical signal incident on the PSR 220 from the second modulator 240, with a time difference relative to the optical signal incident from the first modulator 230, by controlling the phase modulation values of the phase modulators 233, 235, 243, and 245 provided in the first modulator 230 and the second modulator 240. A detailed description thereof is the same as that of the transmitting device 100 and thus will be omitted.

As described above, the transmitting device and receiving device for quantum key distribution according to the present invention are configured to use a single light source, enabling the miniaturization of the size of the devices for quantum key distribution.

In addition, by being configured to allow only a single polarization to pass through, the performance can be improved.

Further, by enabling the internal configuration of the transmitting device and receiving device to be implemented identically, the efficiency of device fabrication can be enhanced.

While the description above describes various preferred embodiments of the present invention with some examples, it should be understood that the description of the various embodiments described in this “detailed description of the invention” section is merely illustrative, and those skilled in the art to which the present invention belong can modify the present invention from the above description to perform various other embodiments, or to perform embodiments equivalent to the present invention.

In addition, it should be understood that the present invention are not limited by the description above, as the present invention may be implemented in a variety of other forms, and that the above description is provided only to make the disclosure of the present invention complete and to inform those skilled in the art to which the present invention belong of the scope of the present invention, and that the present invention are only defined by the respective claims of the claims.

### DESCRIPTION OF REFERENCE NUMERALS

100. Transmitting device,
110 and 210. Base,
120 and 250. First beam splitter,
130 and 230. First modulator,
131 and 231. Second beam splitter,
133 and 233. First phase modulator,
135 and 235. Second phase modulator,
137 and 237. Third beam splitter,
140 and 240. Second modulator,
141 and 249. Optical signal delay part,
143 and 241. Fourth beam splitter,
145 and 243. Third phase modulator,
147 and 245. Fourth phase modulator,
149 and 247. Fifth beam splitter,
150 and 220. PSR,
200. Receiving device

What is claimed is:

1. A transmitting device for quantum key distribution based on a chip, comprising:
a base with one light entrance and one light exit formed;
a first beam splitter positioned inside the base and disposed in a first optical path extending from the light entrance, configured to reflect part of an optical signal incident through the first optical path on a second optical path and transmit a remaining part of the optical signal to a third optical path;
a first modulator positioned inside the base and configured to modulate a phase of an optical signal reflected from the first beam splitter and incident on the second optical path;
a second modulator positioned inside the base, and configured to delay the optical signal transmitted from the first beam splitter and incident on the third optical path for a predetermined period of time and modulate a phase of the optical signal; and
a polarization splitter-rotator positioned inside the base, and configured to transmit an optical signal incident from the second modulator, with a time difference relative to an optical signal from the first modulator, to the one light exit.

2. The transmitting device of claim 1, wherein the first modulator includes:
a second beam splitter configured to reflect part of an optical signal reflected from the first beam splitter and incident through the second optical path on a second-first optical path and transmit a remaining part of the optical signal to a second-second optical path;
a first phase modulator configured to modulate a phase of an optical signal incident from the second beam splitter through the second-first optical path;
a second phase modulator configured to modulate a phase of an optical signal incident from the second beam splitter through the second-second optical path; and
a third beam splitter configured to receive an optical signal incident from the first phase modulator and an optical signal incident from the second phase modulator.

3. The transmitting device of claim 1, wherein the second modulator includes:
an optical signal delay part configured to delay an optical signal transmitted from the first beam splitter and incident through the third optical path for a predetermined period of time and then emits the optical signal;
a fourth beam splitter configured to transmit part of an optical signal incident through the optical signal delay part on a third-first optical path and reflect a remaining part of the optical signal to a third-second optical path;
a third phase modulator configured to modulate a phase of an optical signal incident from the fourth beam splitter through the third-first optical path;
a fourth phase modulator configured to modulate a phase of an optical signal incident from the fourth beam splitter through the third-second optical path; and
a fifth beam splitter configured to receive an optical signal incident from the third phase modulator and an optical signal incident from the fourth phase modulator.

4. The transmitting device of claim 1, wherein phase modulation values of the first phase modulator and the second phase modulator provided in the first modulator, and the third phase modulator and the fourth phase modulator provided in the second modulator, are controlled such that intensity or a phase of an optical signal incident on the polarization splitter-rotator from the second modulator is modulated with a time difference relative to an optical signal incident on the polarization splitter-rotator from the first modulator.

5. The transmitting device of claim 4, wherein the phase modulation values of the first phase modulator and the second phase modulator in the first modulator are controlled to be identical, and the phase modulation values of the third phase modulator and the fourth phase modulator in the second modulator are controlled to be identical, such that the optical signal incident on the polarization splitter-rotator from the second modulator, with a time difference relative to the optical signal incident on the polarization splitter-rotator from the first modulator, has a phase difference.

6. The transmitting device of claim 4, wherein the phase modulation values of the first phase modulator and the second phase modulator in the first modulator are controlled so that a phase difference between an optical signal emitted from the first phase modulator and an optical signal emitted from the second phase modulator is x, and the phase modulation values of the third phase modulator and the fourth phase modulator in the second modulator are controlled so that a phase difference between an optical signal emitted from the third phase modulator and an optical signal emitted from the fourth phase modulator is zero, resulting in an optical signal being emitted only from the second modulator.

7. The transmitting device of claim 4, wherein the phase modulation values of the first phase modulator and the second phase modulator in the first modulator are controlled so that a phase difference between an optical signal emitted from the first phase modulator and an optical signal emitted from the second phase modulator is zero, and the phase modulation values of the third phase modulator and the fourth phase modulator in the second modulator are controlled so that a phase difference between an optical signal emitted from the third phase modulator and an optical signal emitted from the fourth phase modulator is x, resulting in an optical signal being emitted only from the first modulator.

8. The transmitting device of claim 1, wherein the polarization splitter-rotator polarization-modulates and combines an optical signal incident from the first modulator, and intactly combines an optical signal incident from the second modulator.

9. The transmitting device of claim 1, wherein an additional light entrance is formed in the base.

10. A receiving device for quantum key distribution based on a chip, comprising:
a base with one light entrance and two light exits formed;
a polarization splitter-rotator positioned inside the base and disposed on a first optical path extending from the light entrance;
a first modulator positioned inside the base and configured to modulate a phase of an optical signal incident from the polarization splitter-rotator through a second optical path;
a second modulator positioned inside the base and configured to modulate a phase of an optical signal incident from the polarization splitter-rotator through a third optical path and delay an emitted optical signal for a predetermined period of time; and
a first beam splitter positioned inside the base and configured to, depending on an interference result, transmit an optical signal incident from the first modulator and an optical signal incident from the second modulator to one of the two light exits.

11. The receiving device of claim 10, wherein the first modulator includes:
a second beam splitter configured to reflect part of an optical signal reflected from the polarization splitter-rotator and incident on a second-first optical path through the second optical path and transmit a remaining part of the optical signal to a second-second optical path;
a first phase modulator configured to modulate a phase of an optical signal incident from the second beam splitter through the second-first optical path;
a second phase modulator configured to modulate a phase of an optical signal incident from the second beam splitter through the second-second optical path; and
a third beam splitter configured to receive an optical signal incident from the first phase modulator and an optical signal incident from the second phase modulator.

12. The receiving device of claim 10, wherein the second modulator includes:
a fourth beam splitter configured to transmit part of an optical signal incident from the polarization splitter-rotator through the second optical path to a third-first optical path and reflect a remaining part of the optical signal to a third-second optical path;
a third phase modulator configured to modulate a phase of an optical signal incident from the fourth beam splitter through the third-first optical path;
a fourth phase modulator configured to modulate a phase of an optical signal incident from the fourth beam splitter through the third-second optical path;
a fifth beam splitter configured to receive an optical signal incident from the third phase modulator and an optical signal incident from the fourth phase modulator; and
an optical signal delay part configured to delay an optical signal emitted from the fifth beam splitter for a predetermined period of time.

13. The receiving device of claim 10, wherein phase modulation values of the first phase modulator and the second phase modulator provided in the first modulator, and the third phase modulator and the fourth phase modulator provided in the second modulator, are controlled such that intensity or a phase of an optical signal incident on the first beam splitter from the second modulator is modulated with a time difference relative to an optical signal incident on the first beam splitter from the first modulator.

14. The receiving device of claim 10, wherein the polarization splitter-rotator, depending on a polarization mode of an optical signal incident through the first optical path, cither branches the optical signal incident through the first optical path as is or modulates polarization of a signal transmitted in a specific path and transmits the modulated signal.
